(19) United States
(12) Patent Application Publication
(10) Pub. No.: US 2024/0141092 A1
(43) Pub. Date: May 2, 2024

(54) POLYURETHANE MDI FOAM FORMING COMPOSITION INCLUDING EPOXIDIZED SOYBEAN OIL, POLYURETHANE FOAM MADE FROM THE COMPOSITION, AND METHOD OF MAKING POLYURETHANE FOAM

(71) Applicant: LEAR CORPORATION, Southfield, MI (US)

(72) Inventors: Chi-Fan HSU, Farwell, MI (US); Matthew PHILLIPS, Farwell, MI (US); Mike WALKOWSKI, Farwell, MI (US); Paul FIELDING, Harrison, MI (US); Don HANBY, Millbrook, AL (US); Wu Pan ZAGORSKI, Clawson, MI (US); Michelle A. PERENY, Farmington Hills, MI (US)

(73) Assignee: LEAR CORPORATION, Southfield, MI (US)

(21) Appl. No.: 17/966,434

(22) Filed: Oct. 14, 2022

(51) Int. Cl. C08G 18/08; C08G 18/12; C08G 18/34; C08G 18/48; C08G 18/76; C08J 9/12

(52) U.S. Cl. CPC C08G 18/14; C08G 18/12; C08G 18/345; C08G 18/4829; C08G 18/7664; C08J 9/125; C08G 2101/00

(57) ABSTRACT

A composition for forming a polyurethane foam is provided using polyol having a total unsaturation less than 0.04 meq/g, methylene diphenyl diisocyanate (MDI), and epoxidized soybean oil. The epoxidized soybean oil may comprise greater than about 5% by weight of the composition. A method for forming polyurethane foam using the aforementioned composition is also provided.

### TECHNICAL FIELD

The present disclosure relates to formulations and methods for making improved polyurethane foams.

### BRIEF DESCRIPTION OF THE DRAWINGS

FIG. 1 illustrates vibration transmissibility test results of foams in accordance with embodiments of the present disclosure; and

FIG. 2 illustrates damping testing, including initial deflection, test results of foams in accordance with embodiments of the present disclosure.

### DETAILED DESCRIPTION

Reference will now be made in detail to embodiments, examples of which are illustrated in the accompanying drawings. In the following detailed description, numerous specific details are set forth to provide a thorough understanding of the various described embodiments. However, it will be apparent to one of ordinary skill in the art that the various described embodiments may be practiced without these specific details. In other instances, well-known methods, procedures, and components have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

Except in the examples, or where otherwise expressly indicated, all numerical quantities in this description indicating amounts of material or conditions of reaction and/or use are to be understood as modified by the word “about” in describing the broadest scope of the disclosure. Practice within the numerical limits stated is generally preferred. Also, unless expressly stated to the contrary: percent, “parts of, and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the disclosure implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the disclosure can be obtained within a range of +/−5% of the indicated value.

As used herein, the term “and/or” means that either all or only one of the elements of said group may be present. For example, “A and/or B” shall mean “only A, or only B, or both A and B”. In the case of “only A”, the term also covers the possibility that B is absent, i.e. “only A, but not B”.

It is also to be understood that this disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

The term “comprising” is synonymous with “including,” “having,” “containing,” or “characterized by.”

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The phrase “composed of” means “including” or “consisting of.” Typically, this phrase is used to denote that an object is formed from a material.

With respect to the terms “comprising,” “consisting of,” and “consisting essentially of,” where one of these three terms is used herein, the presently disclosed subject matter can include the use of either of the other two terms.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The term “one or more” means “at least one” and the term “at least one” means “one or more.” The terms “one or more” and “at least one” include “plurality” and “multiple” as a subset. In a refinement, “one or more” includes “two or more.”

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4, . . . 97, 98, 99, 100. Similarly, when any range is called for, intervening numbers that are increments of the difference between the upper limit and the lower limit divided by 10 can be taken as alternative upper or lower limits. For example, if the range is 1.1 to 2.1 the following numbers 1.2, 1.3, 1.4, 1.5, 1.6, 1.7, 1.8, 1.9, and 2.0 can be selected as lower or upper limits.

When referring to a numeral quantity, in a refinement, the term “less than” includes a lower non-included limit that is 5 percent of the number indicated after “less than.” For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, or 1 percent of the number indicated after “less than.”

Due to their widely ranging mechanical properties and their ability to be relatively easily machined and formed, polyurethane foams have found wide use in a multitude of industrial and consumer applications. In particular, polyurethane foams have been found to be well suited for many applications. Automobiles, for instance, contain a number of components, such as seat cushions and vehicle interior components, such as headrests, that include polyurethane foams. Such polyurethane foams are typically categorized as flexible, semi-rigid, or rigid foams with flexible foams generally being softer, more pliable, and more subject to structural rebound subsequent to loading than rigid foams.

Polyurethanes are formed when isocyanate (NCO) groups (or A-side reactants) react with hydroxyl (OH) and other active hydrogen groups (or B-side reactants). Specifically, a carbamate linkage (or urethane bond) is formed upon the reaction between an isocyanate group and a hydroxyl group. The polyurethane polymer-forming reaction occurs between substances with more than one isocyanate group per molecule (or A-side reactants) and substances with more than one hydroxyl or other active hydrogen group per molecule (B-side reactants). The most common method of polyurethane production is via the reaction of a polyol (a B-side reactant) and an isocyanate (an A-side reactant) which forms the backbone urethane group. A cross-linking agent may also be added.

The present disclosure generally provides compositions for making and methods of making relatively high-quality polyurethane foams. More specifically, it has been found that, by reacting high-molecular weight, high functionality polyols with methylene diphenyl diisocyanate (“MDI”), improved polyurethane foams can be produced. The improved polyurethane foams exhibit improved performance in some desirable characteristics while maintaining performance in other desirable characteristics. Examples of desirable characteristics include dampening effect, compression set, hysteresis loss, vibration transmissibility, and initial deflection.

In embodiments of the present disclosure, a polyurethane foam is formed by mixing a composition comprising a base polyol, a copolymer polyol, methylene diphenyl diisocyanate (MDI), and an epoxidized soybean oil. The reaction formulation will typically contain other components that are generally known in the art of making polyurethane foams. For example, suitable conventional components may include one or more of at least the following, a crosslinker(s), a catalyst(s), a surfactant(s), and a blowing agent(s) (e.g., water).

The mixing of the composition can be performed by mixing streams, wherein each stream may comprise one or more components of the reaction formulation. For example, the polyol and epoxidized soybean oil may be introduced into the mixture from the same stream. However, to keep the epoxidized soybean oil from reacting with the MDI, the epoxidized soybean oil should be introduced into the mixture from a separate stream than the stream that includes the MDI.

Base polyols used in the present disclosure are high molecular weight polyols. Generally, the base polyol has a nominal molecular weight of greater than about 5,600 and less than about 10,550. Polyols outside this range of nominal molecular weights will generally reduce the desirable improvements to the resulting foam. For example, if the nominal molecular weight is less than 5600, the resulting foam may be insufficiently flexible. If the nominal molecular weight is greater than 10,550, the resulting foam may not have good compatibility with other components. In some embodiments, the nominal weight of the polyol is between 6,000 and 9,000. Polyols used in the present disclosure comprised at least 16 hydroxyl groups and not more than 30 hydroxyl groups. If the number of hydroxyl groups is too high, the viscosity may be too high and cause processing difficulties. If the number of hydroxyl groups is too low, the resulting foam may be insufficiently flexible. Some preferred polyols used in the present disclosure have at least 22 hydroxyl groups and no more than 28 hydroxyl groups. Polyols used in the present disclosure have a total unsaturation of less than 0.04 meq/g, and in other embodiments 0-0.04 meq/g, in yet other embodiments 0.005-0.04 meq/g, and in still yet other embodiments of 0.01-0.04 meq/g. An unsaturation above 0.04 meq/g may change the functionality of the polyol. In some embodiments, the polyol will have a nominal equivalent weight of greater than about 2,100 and in some preferred embodiments the polyol will have a nominal equivalent weight of greater than about 2,200 and less than about 2,300. In certain embodiments, the polyol is a poly (oxyalkylene) polymer such as those commercially available from Bayer Material Science under the product number E960. Embodiments of the present disclosure will generally comprise at least about 5% percent by weight of base polyol, based on the total weight of the polyol side formulation. In some preferred embodiments, compositions of the present disclosure will comprise no more than about 95% by weight of base polyol, based on the total weight of the polyol-side formulation.

Any suitable copolymer polyols can be used. In at least one embodiment, the copolymer polyol is styrene-acrylnitride. Embodiments of the present disclosure will generally comprise at least about 0% percent by weight of copolymer polyol, based on the total weight of the polyol-side formulation. In some preferred embodiments, compositions of the present disclosure will comprise no more than about 65% by weight of copolymer polyol, based on the total weight of the polyol-side formulation.

In at least one embodiment, the ratio of polyol-side to MDI is 10-99 parts per 100 parts polyol resin, in other embodiments 15-95 parts per 100 parts polyol resin, and in yet other embodiments 20-90 parts per 100 parts polyol resin.

The use of epoxidized soybean oil is generally known in the art. The present disclosure allows for an increased amount of soybean oil to be used, resulting in improved foam performance. For example, typically 1%-2% of soybean oil is used in the prior art. The present disclosure allows for up to about 15% of soybean oil to be used in some embodiments. The term “epoxidized soybean oil” means a mixture of organic compounds obtained from the epoxidation of soybean oil. This mixture includes fatty acid chains that include epoxy groups. Soybean oil includes triglycerides with ester linkages formed from the unsaturated fatty acids alpha-linolenic acid, linoleic acid, or combinations thereof and the saturated acid oleic acid. In a refinement, epoxidized soybean oil includes epoxidized linoleum having formula I:

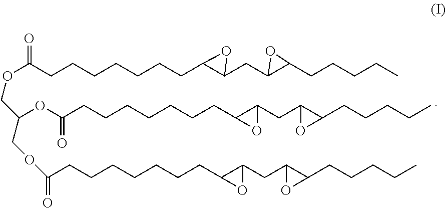 [SMILES: CCCCCC1OC1CC1OC1CCCCCCCC(=O)OCC(COC(=O)CCCCCCCC1OC1CC1OC1CCCCC)OC(=O)CCCCCCCC1OC1CC1OC1CCCCC]

It should be appreciated that any C—H group herein can be substituted with an alkyl group, halide, nitro, cyano, hydroxyl, and the like.

The term “polyol” means an organic compound that contains at least two hydroxyl groups.

The term “unopened epoxide ring” means that 95% of the epoxide rings on the triglyceride are unopened. In a refinement, it means that 90% of the epoxide rings are unopened. In yet another refinement, it means that 80% of the epoxide rings are unopened. In a further refinement, “unopened epoxide ring” means that 70% of the epoxide rings on the triglyceride are unopened.

The term “hydroxyl number” used herein means the milligrams of potassium hydroxide needed to neutralize the acetic acid resulting from the acetylation of one gram of a substance with a free hydroxyl group.

The term “flashpoint” used herein means the lowest temperature at which a volatile material's vapors will ignite.

The term “specific gravity” used herein means the ratio of the density of a substance to the density of water.

In a variation, the epoxidized triglyceride is an epoxidized soybean oil with unopened epoxide rings. The soybean oil replaces a portion of the polyol used in polyurethane foam formation to decrease use of petroleum based polyols and increase sustainability. In a refinement, the epoxidized soybean oil has a flashpoint of 299° C. and a density of 1.04 g/mL. In a variation, the weight ratio of the epoxidized triglyceride to the polyol is less than 0.5. In a variation, the weight ratio of the epoxidized triglyceride to the polyol is from about 0.2 to 0.3. In a further variation, the weight ratio of the epoxidized triglyceride to the polyol is from about 0.05 to 0.15. Separately, the epoxidized triglyceride is present in an amount from about 2 to 10 weight percent of the total weight of the composition for forming polyurethane foams. In a variation, the epoxidized triglyceride is present in an amount from about 6 to 9 weight percent of the total weight of the composition for forming polyurethane foams. In a variation, the epoxidized triglyceride is present in an amount from about 7 to 8 weight percent of the total weight of the composition for forming polyurethane foams.

Embodiments of compositions of the present disclosure will generally comprise at least about 2% percent by weight of epoxidized soybean oil. In some preferred embodiments, compositions of the present disclosure will comprise no more than about 25% by weight of epoxidized soybean oil. In other embodiments, compositions of the present disclosure will comprise 5-15% by weight of epoxidized soybean oil, and in yet other embodiments 6-12% by weight of epoxidized soybean oil, based on the total weight of the polyurethane forming composition. In some embodiments, the epoxidized soybean oil has the properties shown in Table 1:

TABLE 1

| Properties | Typical Values | | Test Method |
|---|---|---|---|
| Physical State | Liquid | | — |
| Color (Gardner) | 1 | | ASTM-D-1554-B1 |
| Specific Gravity at | 0.992 | | ASTM-D-1298 |
| 25° C. (77° F.) | | | |
| Oxirane Oxygen | 7.0% | | AOCS-Cd9 |
| Iodine Value (HANUS) | 1.6 | | AOCS-Tgl-64T |
| Refractive Index at | 1.4710 | | ASTM-D-1218 |
| 25° C. (77° F.) | | | |
| Acid Value | 0.5 | | AOCS-Te-2a |
| Moisture | 0.02% | | ASTM-D-1364-55T |
| Viscosity at 25° C. (77° F.) | M | | — |
| (Gardner) | | | |
| Viscosity at 25° C. (77° F.) | 320 cps | | ASTM-D-2393 |
| (Brookfield) | | | |
| Pour Point | 0° C. | (32° F.) | ASTM-D-97 |
| Flash Point (COC) | 290° C. | (554° F.) | ASTM-D-92 |

| | | |
|---|---|---|
| Odor | Faintly Fatty | — |
| Water Solubility at | 0.01% by wt | — |
| 20° C. (68° F.) | | |
| Molecular Weight (approx.) | 1000 | — |

The epoxidized soybean oil used in some embodiments is commercially available from Galata Chemicals under the trademark Drapex® 6.8.

Tests were run on reaction formulations using three different polyols. The properties of the three different polyols are shown in Table 2.

TABLE 2

| Physical Property | Unit | P1 | P2 | P3 |
|---|---|---|---|---|
| Viscosity at 25 C. | (cps) | 1000-1300 | 1200-1600 | 1600-1850 |
| Specific Gravity | (g/ml) | 1.01 | 1.01 | 1.02 |
| at 25 C. | | | | |
| Water solubility | | insoluble | insoluble | insoluble |
| Flash point | (C.) | 194 | 172 | 187 |
| Calculated OH# | (mg | 26-30 | 30-34 | 23-26 |
| | KOH/g) | | | |
| Nominal Functionality | | 3 | 3 | 3 |
| Nominal Equivalent | | 2004 | 1753 | 2290 |
| Weight | | | | |
| Nominal Molecular | | 6012 | 5260 | 6871 |
| Weight | | | | |
| Water Content | (%), Max | 0.05 | 0.06 | 0.07 |
| Total unsaturation | (meq/g) | About 0.12 | <0.12 | <=0.04 |

Polyol P1 is commercially available from Bayer Material Science under the product number M3901, polyol P2 is commercially available from Bayer Material Science under the product number E863, and polyol P3 is commercially available from Bayer Material Science under the product number E960.

Three polyurethane foam samples were created by mixing reaction formulations comprising MDI and either polyol P1 or polyol P3. The reaction formulation mixed to create the first foam sample (S1) included 83.60% by weight of polyol P1, 33% by weight of MDI, and 0% by weight of epoxidized soybean oil. The reaction formulation mixed to create the second foam sample (S2) included 83.60% by weight of polyol P3, 33% by weight of MDI, and 5% by weight of epoxidized soybean oil. The reaction formulation mixed to create the third foam sample (S3) included 76.60% by weight of polyol P3, 33% by weight of MDI, and 12% by weight of epoxidized soybean oil.

Vibration transmissibility tests and dampening tests were performed on each of the foam samples in accordance with SAE J2896. Table 3 shows the results of the transmissibility tests and Table 4 shows the results of the dampening tests.

TABLE 3

| Sample ID | S1 | S2 | S3 |
|---|---|---|---|
| Resonance Frequency | 4.05 | 4.09 | 3.95 |
| Peak Transmissibility | 3.23 | 3.35 | 2.93 |
| Attenuation Frequency | 6.04 | 6.03 | 5.95 |

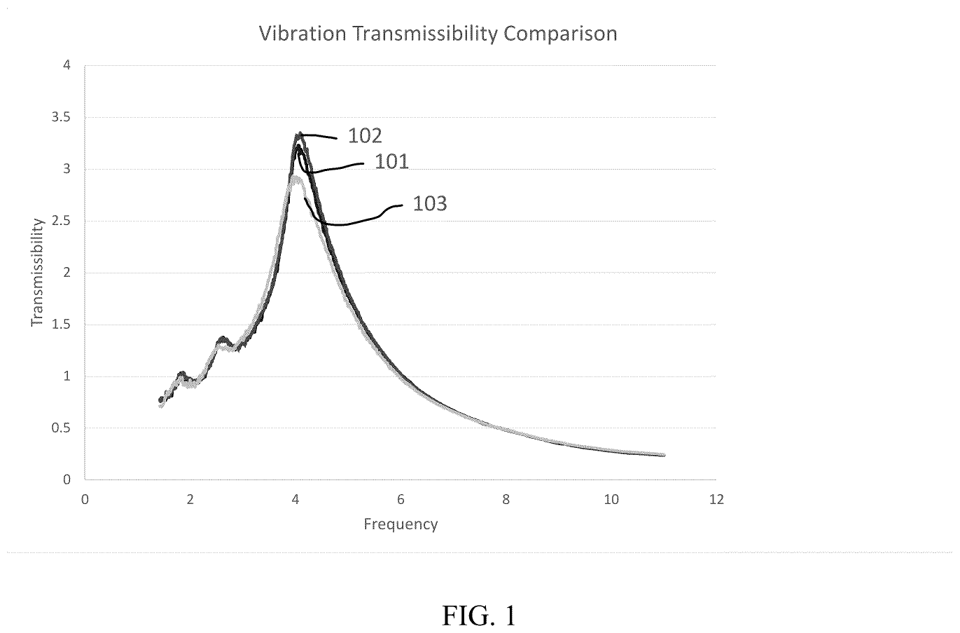

FIG. 1 shows a transmissibility curve 101 for sample S1, a transmissibility curve 102 for sample S2, and a transmissibility curve 103 for sample S3. Table 3 shows that sample S3 has a peak transmissibility of 2.93. Accordingly, both FIG. 1 and Table 3 demonstrate that the foam of sample S3 exhibited a peak transmissibility of less than 3, which is significantly less that the peak transmissibility of sample S1 and sample S2.

TABLE 4

| | | | | | Three | |
|---|---|---|---|---|---|---|
| Sample | Final | Repul- | Loga- | Initial | Cycle | Natural |
| ID | Position | sion | rithmic | Deflection | Time | Frequency |
| S1 | −2.12 | 44.84% | 1.33 | 37.53 mm | 0.89 | 3.37 |
| S2 | −2.25 | 43.8% | 1.3 | 36.45 mm | 0.91 | 3.31 |
| S3 | 11.42 | 41.48% | 1.34 | 17.03 mm | 0.87 | 3.44 |

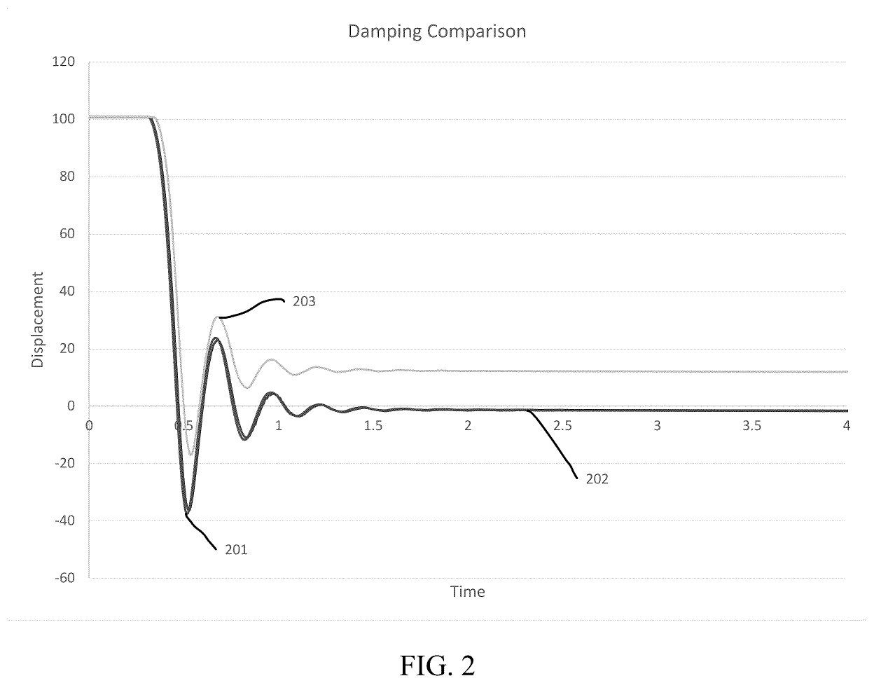

FIG. 2 shows a displacement curve 201 for sample S1, a displacement curve 202 for sample S2, and a displacement curve for sample S3. It should be noted that the displacement curve 201 for sample S1 and the displacement curve for sample S2 are nearly identical. Accordingly, both FIG. 2 and Table 4 demonstrate that the foam of sample S3 has an initial deflection of less than half of the initial deflection of samples S1 and S2. Both FIG. 2 and Table 4 demonstrate that the foam sample S3 exhibits an initial deflection of less than about 20 mm.

The present disclosure demonstrates that higher levels of epoxidized soybean oil can be used in conjunction with high molecular weight, high functionality polyols to produce polyurethane foam having improved properties. While exemplary embodiments are described above, it is not intended that these embodiments describe all possible foams encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A composition for forming a polyurethane foam, the composition comprising:
polyol having a total unsaturation less than 0.04 meq/g;
methylene diphenyl diisocyanate (MDI); and
epoxidized soybean oil, wherein the epoxidized soybean oil comprises greater than about 5% by weight of the composition.

2. The composition of claim 1, wherein the polyol has a molecular weight greater than about 5600 and less than about 10,550.

3. The composition of claim 1, wherein the polyol has a nominal functionality of 3.

4. The composition of claim 1, wherein the epoxidized soybean oil comprises from about 5% to about 15% by weight of the composition.

5. The composition of claim 1, wherein the epoxidized soybean oil comprises from about 10% to about 15% by weight of the composition.

6. The composition of claim 1, wherein the epoxidized soybean oil comprises about 12% by weight of the composition.

7. The composition of claim 1, wherein the polyol is a poly (oxyalkylene) polyol.

8. The composition of claim 1, wherein the polyol comprises from 16 hydroxyl groups to 30 hydroxyl groups

9. The composition of claim 1, wherein the polyol comprises from 22 hydroxyl groups to 28 hydroxyl groups.

10. A polyurethane foam comprising the reaction product of the composition of claim 1.

11. The polyurethane foam of claim 10, wherein the polyurethane foam exhibits a peak transmissibility of less than 3.

12. The polyurethane foam of claim 10, wherein the polyurethane foam exhibits an initial deflection of less than 20.

13. The polyurethan foam of claim 10, wherein the polyurethane foam exhibits a peak transmissibility of less than 3 an initial deflection of less than 20.

14. An article comprising a polyurethane foam according to claim 10.

15. The article of claim 14, wherein the article is a seat cushion or an automobile headrest.

16. A method for forming polyurethane foams in a molding apparatus, the method comprising:
directing a polyol composition into a mold, the polyol composition including a mixture of a polyol having a total unsaturation less than 0.04 meq/g, epoxidized soybean oil, a blowing agent and a catalyst; and
directing an isocyanate composition into the mold to form a foamed polyurethane.

17. The method of claim 16, wherein the epoxidized soybean oil comprises greater than about 5% by weight of the composition.

18. The method of claim 16, wherein the epoxidized soybean oil comprises greater than about 5% by weight of the composition.

19. A molded component comprising the reaction product of a composition comprising:
polyol having a total unsaturation less than 0.04 meq/g;
methylene diphenyl diisocyanate (MDI); and
epoxidized soybean oil, wherein the epoxidized soybean oil comprises greater than about 5% by weight of the composition.

20. The molded component of claim 18 wherein the polyurethane foam is included in a seat cushion, a headrest, or an arm rest.
